(19) United States
(12) Patent Application Publication
(10) Pub. No.: US 2018/0230906 A1
(43) Pub. Date: Aug. 16, 2018

(54) AIR INTAKE STRUCTURE FOR AN AIRCRAFT NACELLE

(71) Applicants: AIRBUS OPERATIONS (SAS), Toulouse (FR); AIRBUS (S.A.S.), Blagnac (FR)

(72) Inventors: Alain PORTE, Colomiers (FR); Jacques LALANE, Saint Orens De Gameville (FR); Franck OUNDJIAN, Bonrepos Sur Aussonnelle (FR)

(21) Appl. No.: 15/892,618

(22) Filed: Feb. 9, 2018

(30) Foreign Application Priority Data
Feb. 10, 2017 (FR) 1751105

(51) Int. Cl. F02C 7/045; B64D 29/00; B64D 33/02

(52) U.S. Cl. CPC F02C 7/045; B64D 2033/0206; B64D 33/02; B64D 29/00

(57) ABSTRACT

An air intake structure for an aircraft nacelle including an air intake lip with a U-shaped cross section which is open towards the rear, with a rear end, an acoustic panel including an inner wall, wherein the air intake lip has at a rear end a contact surface oriented towards the inside of the air intake lip, in that the contact surface takes the shape of a bevel which points towards the rear and against which the inner wall is placed, in that at the point of the bevel, the inner wall runs on from the air intake lip and in that level with the contact surface, the air intake lip is fixed to the inner wall by first fasteners. The bevelled shape restricts the possibility of dust and water being halted in their progress and blocking up the air intake structure as a result.

### RELATED APPLICATION

This application claims priority to French patent application 1751105 filed Feb. 10, 2017, the entirety of which is incorporated by reference.

### TECHNICAL FIELD

The present invention relates to an air intake structure for a nacelle housing an aircraft engine.

### BACKGROUND OF THE INVENTION

An aircraft engine is housed in a nacelle which may be mounted by a pylon to an underside of a wing or the side of a fuselage. The nacelle is typically annular in cross section. The nacelle includes an air intake structure 300 at its front. The air intake is depicted in FIG. 3A.

In the context of this patent document, the terms “front” and “rear” are with respect to the front and rear of the aircraft engine.

The air intake structure 300 generally comprises an inner face 302 and an outer face 304 in contact with the outside air, whereas the inner face 302 delimits a flow path 306 which constitutes the fan duct. The function of the air intake structure is to ensure the aerodynamic flow of the air, firstly towards the fan duct 306 and secondly towards the outside of the nacelle.

The air intake structure 300 comprises an air intake lip 308, a front reinforcing frame 310, an acoustic panel 312 and an outer panel 313. The air intake lip 308 is annular in a cross section taken in a plane perpendicular to an axis of the engine. The cross section along a plane that includes the engine axis U-shaped, wherein the U open towards the rear.

The air intake lip 308 forms an outer casing of a front portion of the air intake structure 300. The air intake lip is at the leading edge of the nacelle. The air intake lip diverts incoming air flow such that some air enters the nacelle and flows to the fan duct 306 and some flows around the outer surface of the nacelle.

The front reinforcing frame 310 likewise is annular in cross section along a plane perpendicular to the engine axis and has a U-shape in a cross section along a plane parallel to the engine axis. The U-shape opens towards the rear and is positioned on the inside and at the rear of the air intake lip 308. The front reinforcing frame 310 provides mechanical strength to the front portion of the nacelle and helps to preserve the shape and the dimensions thereof.

The annular outer panel 313 extends the air intake lip 308 on the outer side and constitutes a portion of the outer face 304 of the nacelle. The annular acoustic panel 312 forms an inner casing for the nacelle. The acoustic panel is behind the air intake lip 308 on the side of the fan duct 306. The acoustic panel 312 forms a portion of the inner face 302 of the nacelle.

The acoustic panel 312 is a structure capable of attenuating noises produced by the engine, such as the fan. This acoustic panel 312 is formed of a composite sandwich type material. The material may include a honeycomb core 312a sandwiched between an inner wall 312c and an outer wall 312b. The inner wall 312c delimits the fan duct 306 and extends the air intake lip 308, whereas the outer wall 312b is on the inside of the air intake structure 300 but oriented towards the outside of the nacelle.

The front portion of the acoustic panel 312 has no honeycomb core. At the front portion of the acoustic panel, the inner wall 312c and the outer wall 312b overlap, are side by side and pressed against each other.

On the side of the inner face 302, the front reinforcing frame 310 is fixed firstly to the air intake lip 308, for example by means of rivets 314, symbolized by a dot-dash line, and secondly to the acoustic panel 312 level with its front portion, for example by means of rivets 316, symbolized by a dot-dash line.

On the side of the outer face 304, the front reinforcing frame 310 is fixed firstly to the air intake lip 308, for example by means of rivets 315, and secondly to the outer panel 313 by rivets 317.

Although an air intake structure 300 of this kind is entirely satisfactory when it comes to use, there are disadvantages associated with its maintenance. During assembly the rear end of the air intake lip 308 and the front end of the inner wall 312c are facing one another, but due to the construction tolerances these two ends are at a distance from one another, thereby creating a gap 318 between them. FIG. 3B shows an enlargement of zone III in FIG. 3A.

The gap 318 is exposed to air flow which penetrates the fan duct 306 and moves water and dust into the gap. To prevent these elements (water, dust) from accumulating in the gap 318, it is necessary to attach a plugging element which closes the gap 318. The plugging element is, for example, a seal or a slat fixed to the inside of the fan duct 306.

During maintenance of the nacelle, it is necessary to remove the plugging element, clean the gap, and reinstall or replace the plugging element. This process extends the maintenance period of the nacelle.

### DISCLOSURE OF THE INVENTION

The invention disclosed herein may be embodied as an air intake structure with a shorter maintenance time. To this end, an air intake structure for a nacelle of an aircraft is proposed, wherein the air intake structure comprising:

(i) an air intake lip with a U-shaped cross section and is open towards the rear, and

(ii) an acoustic panel comprising an inner wall,

wherein the air intake structure includes an air intake lip that has at its rear end a contact surface oriented towards the inside of the air intake lip, in that the contact surface takes the shape of a bevel which points towards the rear and against which the inner wall is placed, in that at the point of the bevel, the inner wall runs on from the air intake lip and in that level with the contact surface, the air intake lip is fixed to the inner wall by first fixing means, e.g., fasteners.

The bevel shape restricts the possibility of dust and water being halted in their progress and blocking up the air intake structure as a result.

Advantageously, the air intake structure comprises a front reinforcing frame fixed on the inside and at the rear of the air intake lip and attached to the air intake lip by second fixing means, e.g., fasteners.

Advantageously, the acoustic panel incorporates a honeycomb core between the inner wall and an outer wall, the air intake structure comprises a reinforcement which has a U-shaped section that is open towards the front and exhibiting a bottom, a first branch and a second branch, the first branch is supported against the inner wall, the outer wall is supported against the second branch and the bottom is supported and fixed against the core.

The invention likewise proposes a nacelle for an aircraft engine exhibiting an air intake structure according to one of the preceding variants. The invention likewise proposes an aircraft comprising at least one nacelle according to the preceding variant.

### BRIEF DESCRIPTION OF THE DRAWINGS

The aforementioned characteristics of the invention, as well as others, will become more clearly apparent on reading the following description of an exemplary embodiment, said description being provided in relation to the attached drawings, in which:

FIG. 1 is a side view of an aircraft exhibiting an air intake structure according to the invention,

FIG. 2 is a sectional view of an air intake structure according to the invention,

FIG. 3A is a sectional view of an air intake structure of a state-of-the-art aircraft, and

FIG. 3B is an enlargement of zone III in FIG. 3A.

### DETAILED DISCLOSURE OF EMBODIMENTS

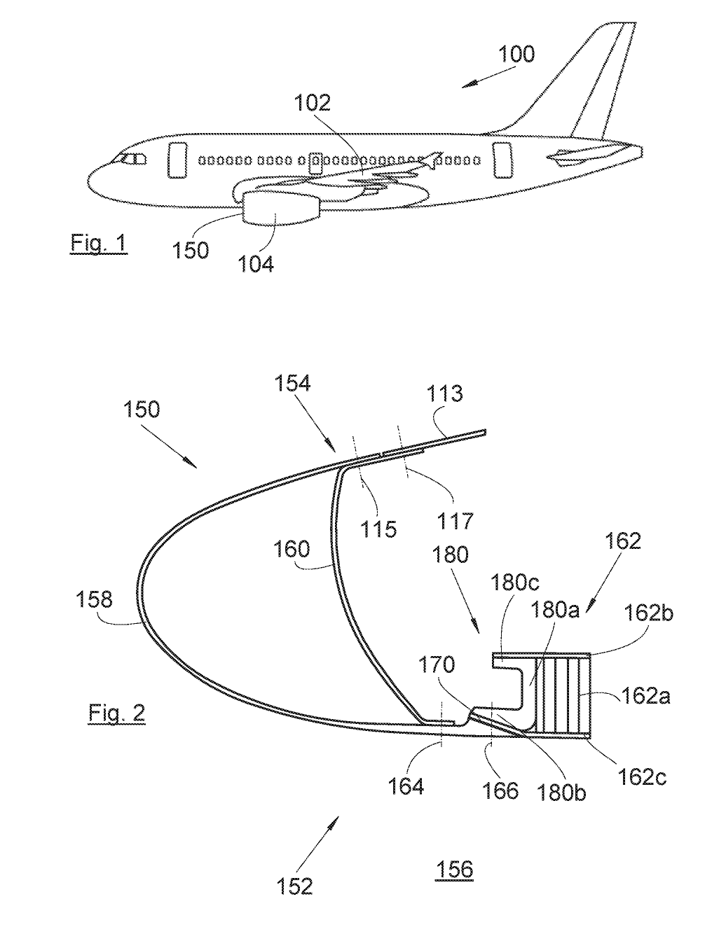

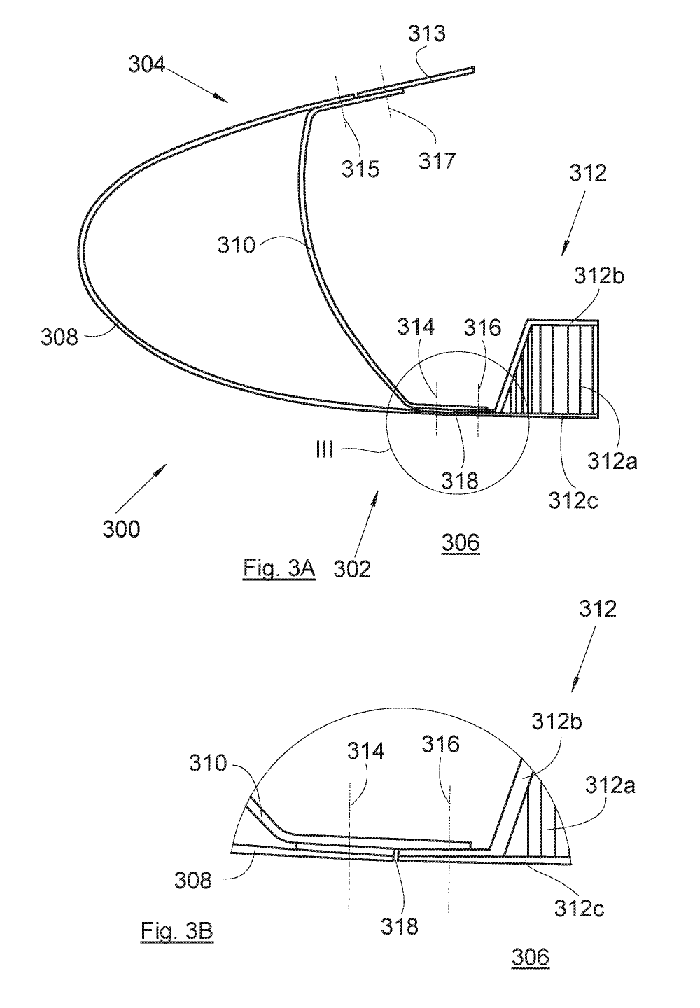

FIG. 1 shows an aircraft 100 with wings 102. Beneath and attached to each wing is a nacelle 104 which houses an engine. The front of the nacelle 104 includes an air intake structure 150, a section of which is depicted in FIG. 2. The air intake structure 150 may be a skin or other sheet of material.

The nacelle includes an air intake structure 150 having an inner face 152 and an annular outer face 154 in contact with the outside air. The inner face 152 is annular and defines a flow path 156 through the nacelle which constitutes the fan duct.

The air intake structure 150 is annular and forms a leading edge of the nacelle. The air intake structure 150 comprises, among other things, an annular air intake lip 158, an annular acoustic panel 162 and an annular outer panel 113. The air intake lip 158 is U-shaped in cross section along a plane parallel to and extending through an axis of the nacelle. The U-shape of the air intake lip is open towards the rear. The air intake lip forms the outer casing of the front portion of the air intake structure 150. The air intake lip diverts air at the leading edge of the nacelle into the nacelle and over an outer surface of the nacelle.

The outer panel 113 extends the air intake lip 158 and forms a portion of the outer face 154 of the air intake structure.

The acoustic panel 162 forms a portion of the inner casing of the nacelle 104. The acoustic panel 162 near the rear of the air intake lip 158, and on the side of the nacelle facing the fan duct 156. The acoustic panel 162 constitutes a portion of the inner face 152.

The acoustic panel 162 may have a honeycomb core 162a sandwiched between an inner wall 162c and an outer wall 162b. The inner wall 162c forms a portion of the inner face and thus an outer wall of the fan duct 156. The inner wall 162 and extends to the air intake lip 158. The outer wall 162b is part of the air intake structure 150 and is oriented, e.g. faces, towards the outside of the nacelle 104.

The front portion of the acoustic panel 162 does not have a honeycomb core but the inner wall 162c and the outer wall 162b remain distant one from the other.

The air intake lip 158 has at its rear end a contact surface 170 which is oriented towards the inside of the air intake lip 158. The contact surface may take the shape of a crown or of a crown portion, e.g., frustoconical, around the axis of the nacelle 104. The contact surface is part of an inside surface of the air intake lip 158 and thus is on a side of the air intake lip opposite to the side forming the wall of the fan duct 156.

The inner wall 162 may have a forward region that slants radially outward with respect to the axis of the nacelle. The forward region may be frustoconical, bevelled or otherwise shaped to seat against the contact surface 170 of the air intake lip.

The inner wall 162c is placed against a contact surface 170 of the air intake lip 158. The air intake lip 158 remains on the side of the fan duct 156 with respect to the inner wall 162c. The junction between the air intake lip 158 and the inner wall 162c is formed by the junction of the contact surface 170 and the forward region of the inner wall 162c. The inner wall 162c progresses from its forward region rearward to a region that faces radially inward towards the fan duct and forms an annular portion of the wall that forms the fan duct. At the contact surface 170, the air intake lip 158 is fixed to the inner wall 162c by appropriate first fixing fasteners 166 such as, for example, rivets or screw/nut systems. The first fixing fasteners 166 are symbolized by a dot-dash line in FIG. 2.

In cross section along a plane parallel to and extending through an axis of the nacelle, the contact surface 170 may take the shape of a bevel which is oriented towards the inside of the air intake lip 158 and which points towards the rear of the air intake lip 158 and therefore of the nacelle 104. In other words, the air intake lip 158 tapers through the inside of the air intake lip 158, progressing rearwards from the front level with the contact surface 170.

The wall of the fan duct extends rearward from the air intake lip 158 directly to the inner wall 162. The trailing edge of the air intake lip 158 abuts a slanted portion of the surface of the forward region of the inner wall 162c. Thus, the transition between the air intake lip and the inner wall 162c is a smooth transition between two slanted surfaces and any gap between the surfaces is minimal.

At the point of the bevel oriented towards the rear, the inner wall 162c runs on from the air intake lip 158 and as a result there is no crevice between the inner wall 162c and the air intake lip 158 in which dust or water could accumulate. It is therefore no longer necessary to provide a plugging element and the maintenance time is shorter.

The air intake structure 150 comprises a front reinforcing frame 160 which in cross section is a U-shaped section which is open towards the rear. The air intake structure is positioned on the inside and at the rear of the air intake lip 158. The front reinforcing frame 160 ensures the mechanical strength of the front portion of the nacelle 104 and helps to preserve the shape and the dimensions thereof.

From the side of the inner face 152, the front reinforcing frame 160 is fixed to the air intake lip 158, for example by means of second fasteners 164 such as rivets symbolized by a dot-dash line in FIG. 2.

On the side of the outer face 154, the front reinforcing frame 160 is fixed firstly to the air intake lip 158, for example by means of rivets 115, and secondly to the outer panel 113 by means of rivets 117.

To reinforce the rigidity of the acoustic panel 162, the air intake structure 150 comprises a reinforcement 180 which has a U-shaped in cross section that is open towards the front. The reinforcement 180 may be an annular beam formed of carbon fibres. The reinforcement 180 exhibits a web 180a, a first branch 180b and a second branch 180c. The branches 180b and 180c are integral. The branches 180b, 180c may have parallel opposing surfaces which are parallel to the axis of the nacelle. The web 180a may be in a plane perpendicular to the axis of the nacelle.

The first branch 180b supports and is fixed against the inner wall 162c. The outer surface of the first branch 180b may be bevelled or fustoconical to abut the slanted front portion of the inner wall 162c. The front portion of the inner wall 162c may be sandwiched between the first branch 180b and the contact surface 170. The first fixing fasteners 166 fix the assembly of the air intake lip 158, the inner wall 162c and the first branch 180b.

The outer wall 162b of the acoustic panel 162 is supported and fixed against the second branch 180c of the reinforcement 180.

The web 180a supports or is supported by and is fixed against the core 162a. The length of the web 180a in a radial direction may be substantially equal to a thickness of the core 162a.

The particular shape of the reinforcement 180 likewise makes it possible to maintain a straightness of the outer wall 162b which can then be produced automatically, for example with the help of a robot depositing carbon fibres.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft air intake assembly comprising:
an intake structure for a nacelle of an aircraft, the air intake structure including:
an air intake lip which is U-shaped in cross section, wherein the U-shape opens towards a rear of the air intake lip and
an acoustic panel comprising an inner wall,
wherein the air intake lip includes at a rear end a contact surface oriented towards an inside surface of the air intake lip, wherein the contact surface has a bevel shape which is oriented rearward and abuts the inner wall such that the inner wall extends reward from an abutment between the bevel and the air intake lip; and
first fasteners fixing the bevel to the inner wall;
wherein the acoustic panel includes a honeycomb core layer between the inner wall and an outer wall, and
wherein the air intake structure further comprises a reinforcement which is U-shape in cross section and the U-shape opens forward, wherein the reinforcement includes a web and first and second branches at opposite edges of the web, wherein the first branch abuts the inner wall, the second branch abuts the outer wall, and the web abuts a forward side of the honeycomb core.

2. The aircraft air intake assembly according to claim 1, further comprising a front reinforcing frame positioned and fixed to the air intake lip by second fasteners.

3. The nacelle for an aircraft engine having the air intake structure according to claim 1.

4. An aircraft comprising at least one nacelle according to claim 3.

5. An aircraft comprising:
a nacelle configured to house a propulsion unit for the aircraft;
air intake assembly for the nacelle including:
an air intake lip which has a U-shape cross section and the U-shape is open reward, and
an acoustic panel comprising an inner wall,
wherein the air intake lip includes at a rear end a contact surface oriented towards an inside surface of the air intake lip, wherein the contact surface has a bevel shape oriented reward, and the contact surface abuts the inner wall, wherein the inner wall extends reward from an abutment between the contact surface and the inner wall, and wherein the air intake lip is fixed to the inner wall by first fasteners.

6. An air intake assembly for a nacelle comprising:
an annular air intake having an outer surface forming a leading edge of the nacelle, a radially outer surface forming a portion of an outer surface of the nacelle and a radially inward surface forming a portion of an air duct configured to direct air into an aircraft propulsion unit, wherein the annular air intake has an centreline at a center of the air duct;
a contact surface at a reward end of the inward surface of the annular air intake, wherein the contact surface is annular and slopes radially inwardly along a rearward direction; and
an annular acoustic panel reward and coaxial with the annular air intake, wherein the acoustic panel includes a honeycomb core sandwiched between an annular inner wall and an annular outer wall,
wherein an annular inner wall includes a forward region which slopes radially inward along the reward direction and a reward region which is parallel to the centreline; and
wherein forward region of the annular inner wall abuts and is joined to the contact surface to join the annular air intake to the annular acoustic panel.

7. The air intake assembly of claim 6 wherein the slope of the contact surface matches the slope of the forward region of the annular inner wall.

8. The air intake assembly of claim 6 further comprising an annular reinforcement beam, wherein the reinforcement includes a web and first and second branches at opposite edges of the web, wherein the first branch abuts the forward region of the inner wall, the second branch abuts the outer wall, and the web abuts a forward edged of the honeycomb core.

9. The air intake assembly of claim 6 wherein the contact surface is bevelled, frustoconicalor otherwise slanted with respect to the centerline.

10. The air intake assembly of claim 6 wherein the forward region of the inner wall is bevelled, frustoconicalor otherwise slanted with respect to the centerline.
